(19) United States
(12) Patent Application Publication
(10) Pub. No.: US 2005/0194799 A1
(43) Pub. Date: Sep. 8, 2005

(54) Pet refuse cartridge

(76) Inventors: Jamshid Karimi, Thousand Oaks, CA (US); Keyvan T. Diba, Los Angeles, CA (US)

Correspondence Address: BIRCH STEWART KOLASCH & BIRCH, PO BOX 747, FALLS CHURCH, VA, 22040-0747, US

(21) Appl. No.: 11/120,515

(22) Filed: May 2, 2005

Related U.S. Application Data
(63) Continuation-in-part of application No. 10/620,665, filed on Jul. 16, 2003.

(51) Int. Cl. A01K 29/00

(52) U.S. Cl. 294/1.3

(57) ABSTRACT

A refuse bag composed of flexible plastic sheet material folded into a flat rectangular condition and mounted in a carrier to form a disposable cartridge for use in a manually operable refuse tool. The carrier has a flat bottom wall, upstanding sidewalls, and bag retainers overlying the bottom wall and defining an open front side for withdrawal of the bag, which has a closed end secured to the carrier. A v-notch in the rear side of the carrier leading to a restricted central opening forms a clip for closing the bag around refuse that has been picked up. Three embodiments of the carrier are shown, in cardboard, stiff plastic sheet material, and molded transparent plastic.

### CROSS-REFERENCE TO RELATED APPLICATION

This application is a continuation-in-part of prior copending application Ser. No. 10/620,665 filed Jul. 16, 2003, entitled “PET REFUSE TOOL AND METHOD.”

### BACKGROUND OF THE INVENTION

This invention relates to implements for picking up pet refuse and the like, and has particular reference to a disposable bag for use with a hand tool for picking up the refuse of the general type disclosed in the above-identified application.

As explained in the copending application, many types of tools and procedures have been proposed or provided for use in picking up and disposing of pet refuse, while avoiding touching of the refuse by the user. One such tool is a combined scoop and pushing tool with which refuse is picked up and then simply dumped in a refuse container. A variation of this, sold as the “Pix It Up” system, uses a square frame on an elongated handle and attaches a bag to the frame to receive the refuse as it is scooped up in the frame. The bag is then detached from the scoop for disposal of the refuse. Another product is the “Pet Gold Mini Scissors Scoop” sold by Petco and comprising a plastic scissors for slicing under the refuse and then picking it up for deposit in a bag for disposal. Still another is “Allen's Spring Action Scooper”, also sold by Petco, having spring-loaded clamshell jaws for picking up and then depositing the refuse. Another widely used procedure is the use of a simple flexible plastic bag which the user places over the refuse and then closes and grips to contain the refuse in the bag. While simple and effective, this procedure often involves difficult manipulation of the bag and unpleasant contact of the user's hand with the refuse.

The copending application discloses a hand tool that receives and holds a flexible bag in which the refuse eventually will be discarded in a manner that avoids all contact between the user and the refuse. For these purposes, the compact tool has a handle to be held in one hand, and a gripping head on the handle with a “receiving” opening between two relatively movable jaws, the opening being lined, for use, with a flexible bag that receives the refuse when the tool is placed over the refuse. The bag then is pulled into the tool from the handle side of the head to complete the pick-up of the refuse without need for contact with the user's hands.

### SUMMARY OF THE INVENTION

In accordance with the present invention, disposable bags for the hand tool are provided as easy-to-use and relatively inexpensive disposable cartridges that are insertable in the hand tool to hold a bag available for use when needed, and are activated or readied for use by pulling the bag out of the tool and opening it over the jaws to line the tool during pickup. The bag then is pulled through the tool and closed around the refuse for removal from the tool. The cartridge includes a carrier for insertion in the tool and, after the refuse has been pulled into the tool, for serving as a closure clip for the bag, which then can be separated from the tool and discarded with the enclosed refuse.

Other aspects and advantages of the invention will become apparent from the drawings, taken in conjunction with the accompanying detailed description.

### BRIEF DESCRIPTION OF THE DRAWINGS

FIG. 1 is a front and top perspective view of a preferred embodiment of a pet refuse bag cartridge embodying the novel features of the present invention;

FIG. 2 is a partial side perspective view of the pet refuse tool of the above-identified application, shown in reduced scale and in the “open” position in the hand of a user, with another embodiment of the bag cartridge in place in the tool and about to be extended, or activated for use in picking up a piece of refuse, the hands being shown in broken lines;

FIG. 3 is another perspective view of the tool and cartridge of FIG. 2, in further reduced scale, with the bag extended from the tool;

FIG. 4 is another perspective view showing the cartridge of FIGS. 2 and 3 with the bag then folded back around the tool, in the process of picking up a piece of refuse;

FIG. 5 is another perspective view showing the bag of FIGS. 2 to 4 after the tool has closed on the refuse, the bag having been pulled into the tool by the carrier and about to be sealed around the refuse, also shown in broken lines;

FIG. 6 is a perspective view of the bag of FIG. 1, shown before attachment to the carrier and in the first step of folding;

FIG. 7 is a view similar to FIG. 6 showing the second step of folding;

FIG. 8 is a view similar to FIGS. 6 and 7 showing the next step in folding, and the attachment of the bag to the carrier of FIG. 1, plus attachment of a pull tab;

FIG. 9 (sheet 1 of drawings) is an enlarged perspective view of the bag and carrier of FIG. 1, showing the last two steps in folding and assembly of the bag carrier to form the preferred embodiment of the cartridge;

FIG. 10 is a bottom perspective view of another carrier for another embodiment of the invention, using a plastic carrier formed of stiff sheet plastic, and

FIG. 11 is a bottom perspective view of a second preferred embodiment of the invention, using a molded plastic carrier.

### DETAILED DESCRIPTION OF THE INVENTION

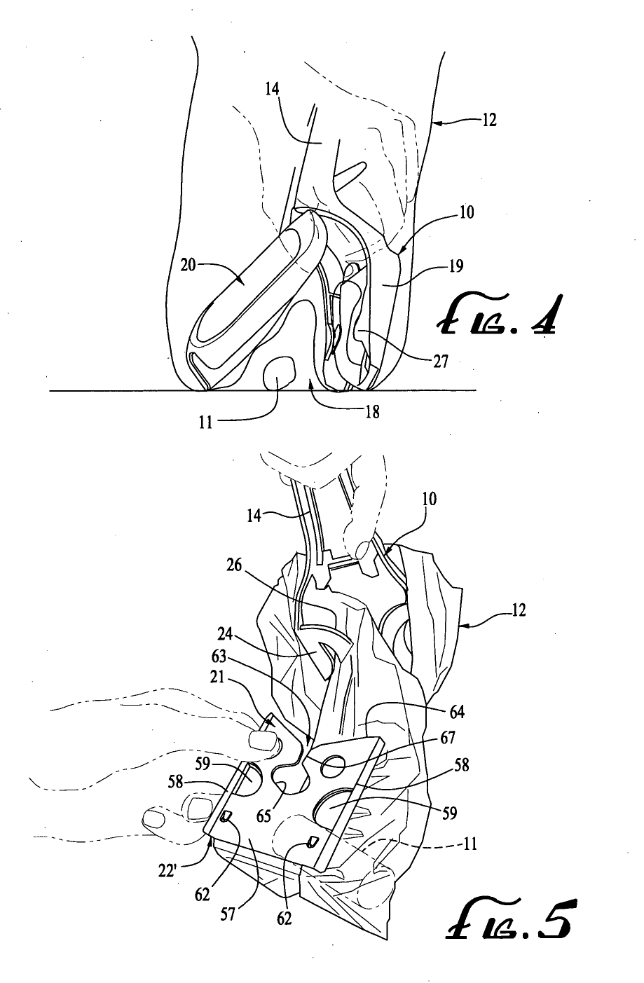

Referring first to FIGS. 2-5, which are taken from the above-identified copending application, one embodiment of the invention is illustrated with a pet refuse tool 10 for picking up refuse such as a piece of pet feces, indicated at 11 in FIGS. 4 and 5, in a flexible disposable bag 12, and holding the refuse in the bag as the bag is withdrawn from the tool for disposal. The tool comprises a handle 14 that can be sized to be gripped in one hand during use, herein being provided with transverse ridges 15 on its upper side for secure gripping. The tool has a gripping head 17 on one end of the handle with a “receiving” opening 18 formed between two relatively movable elements 19 and 20, in the nature of jaws on opposite sides of the opening 18, and the opening is lined, for use, with the flexible bag 12, preferably composed of thin-walled plastic film, with an open-end portion between two opposed sidewalls overlying the adjacent sides of the two jaws (see FIG. 4). When the jaws are spread apart to expand the receiving opening 18, the gripping head 17 can be placed over the refuse 11, thereby placing the bag 12 over the refuse as well, so that closing of the jaws grips the refuse in the receiving opening between opposed walls of the bag. The bag then is pulled farther into the tool to drag the refuse through the gripping head, where a closure clip 21 (FIG. 5) can be applied around the bag to seal the refuse in the bag before the bag is completely removed from the tool 10.

In accordance with the present invention, the bag 12 is assembled on a carrier, indicated generally at 22, to form a bag cartridge 23 that holds a folded bag 12 and can be fitted into the gripping head 17 ready for opening and use on demand. The carrier of the cartridge also provides a convenient grip for pulling the loaded bag further into and through the gripping head 17 and out of the tool 10, and carries the clip 21 for sealing the loaded bag for disposal.

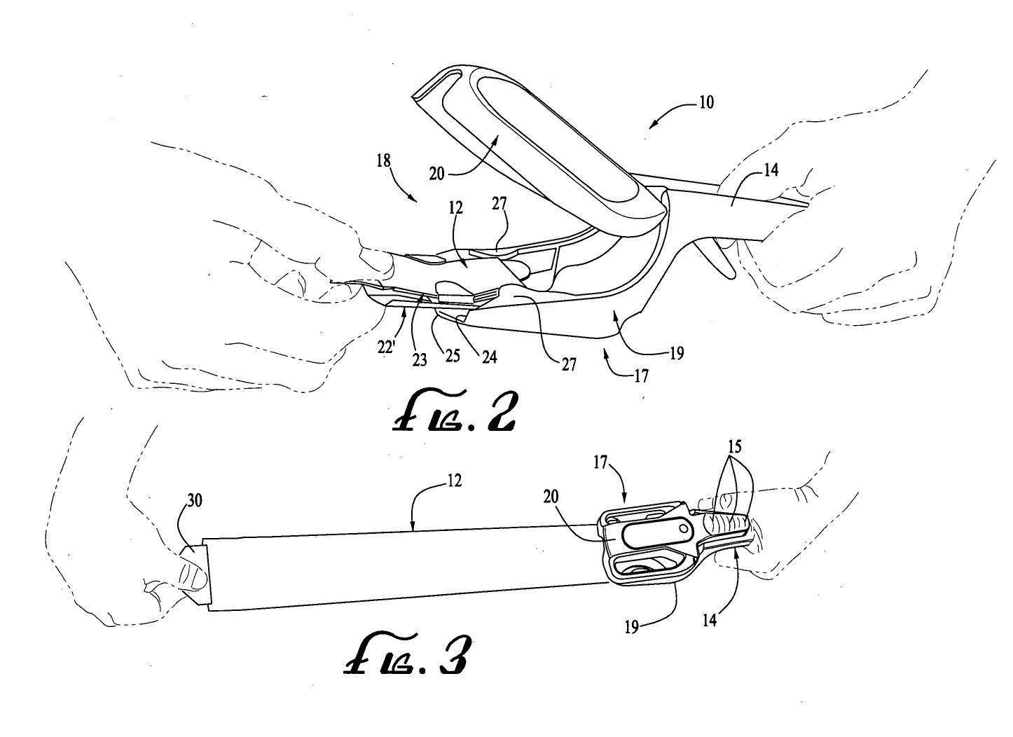

As shown in FIGS. 2 and 3, the lower jaw 19 of the tool 10 has a substantially flat bottom wall 24 having a front edge 25 at the mouth 18 of the tool 10 and a rearwardly opening notch 26, shown in FIG. 5, and the cartridge is conveniently positioned over this wall when it is installed in the tool. Two hold-down ears 27 on the sidewalls 28 of the lower jaw 19 are spaced above the bottom wall 24 to form a mounting slot for receiving and holding a bag cartridge 23 in the tool. The cartridge is shown being inserted in this slot in FIG. 2.

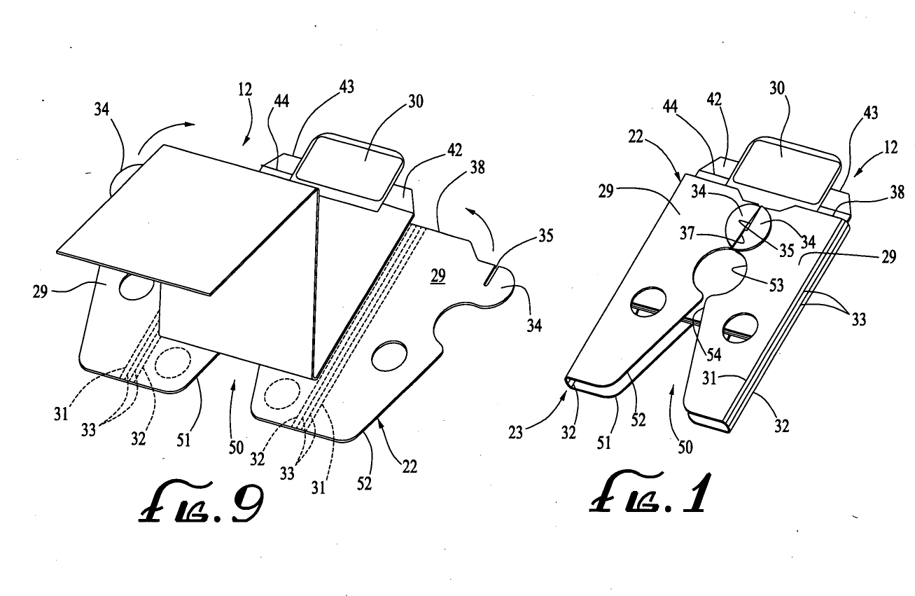

It can be seen in FIGS. 1 and 2 that the cartridge 23 comprises the bag 12 folded and fitted onto the carrier 22, which is a flat, rectangular boxlike structure, the bag being held releasably in place on the carrier by two retainers 29 that are sized to slide under the ears 28 of the lower jaw and to snap into the jaw behind a low, upstanding lip on the front edge 25. When so installed, the cartridge is held releasably in place in the head 17.

For easy opening, the bag 12 has a pull tab 30 on its open end which is disposed above the edge 25 of the jaw when installed in the tool 10 and sticks out of the tool for easy access and gripping. As will be seen, the bag 12 is folded so as to be pulled out of the head into an extended position (FIG. 3), and then opened and folded back the tool is shown in FIG. 4. The inner or closed end of the bag 12 is attached to the carrier 22 preventing inadvertent removal from the cartridge 23 as the bag is extended, and also permitting use of the carrier to pull the bag through the head 17 after the refuse has been picked up in the tool 10.

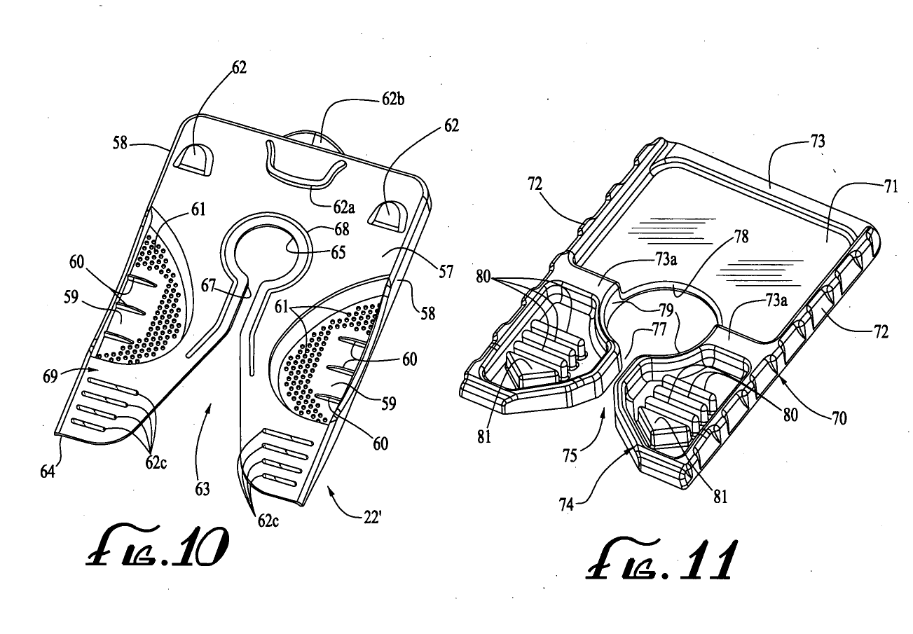

The detailed construction of the cartridge of the first embodiment of the invention is shown most clearly in FIG. 1, wherein it will be seen that the carrier 22 is formed by a sheet of thin material such as heavy paper or die-cut cardboard (shown flat in FIG. 9) with opposite side portions in the shape of wings forming the retainers 29 and a flat central portion for lying under a folded bag 12, the bag being shown partially folded in FIG. 9. The sheet is weakened along fold lines 31 and 32 on both sides of the bag position to facilitate folding of the retainer wings 29, as shown in FIG. 1, over a folded bag. Intermediate weakened lines 33 may be provided so that the edges of the cartridge carrier are more rounded, although those may be omitted if square edges are desired.

Formed on each outer edge of the retainer wings 29 is a tab 34 having an interlocking slot 35 for engaging an oppositely facing slot 37 (FIG. 8) in the tab 34 of the other retainer and joining the retainers together in the folded condition shown in FIG. 1, over the folded bag 12. The tab 30 projects forward from the bag 12 beyond the front edges 38 of the retainers 29 to be accessible when the cartridge 23 is installed in a tool 10.

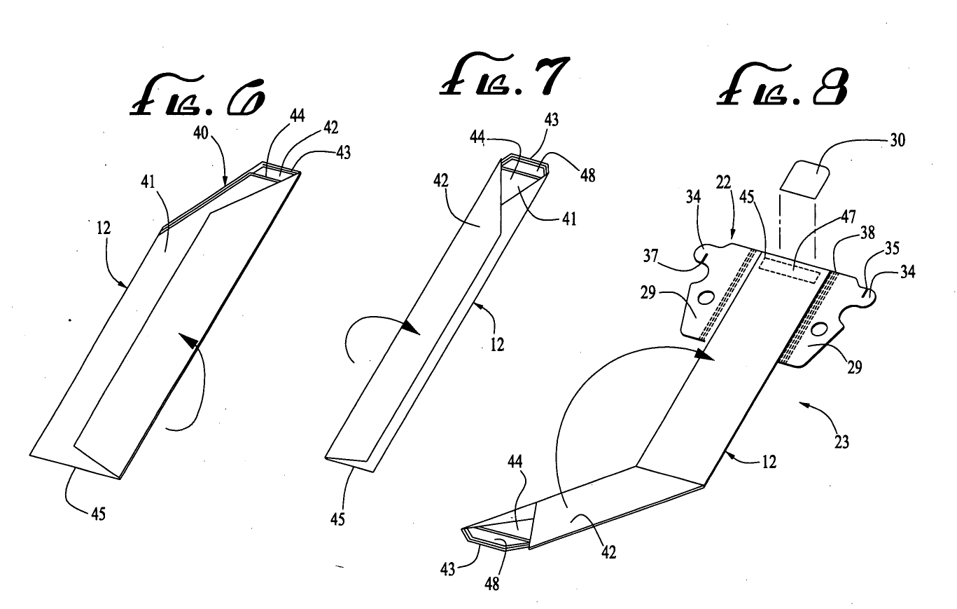

FIGS. 6, 7, 8 and 9 show the steps in folding and installing a bag 12 in a carrier to form a cartridge 23. First, a bag 12 is provided, having an open end 40 which herein is formed between opposite sidewalls 41 and 42, preferably comprised of thin plastic film having edges that are beveled or tapered toward central flat edges 43 and 44. The edge 43 is offset forwardly from the edge 44 to form a narrow exposed front portion of the lower sidewall 42, as shown in FIGS. 6 and 7. The edges preferably are double sealed and thickened for strength.

The end edges 43 and 44 are of selected width to be the width of the folded bag 12, and the portions of the bag on opposite sides of these edges form longitudinal flaps to be folded over the central portion, as shown in FIGS. 6 and 7. Then the elongated, partially folded bag is folded longitudinally to the desired length for the cartridge 23 and secured in the carrier.

Preferably, the closed end portion of the bag 12 first is joined to the carrier 22 by an adhesive or a staple (not shown) at the closed end 45, the upper end in FIG. 8, in the area indicated at 47. The open end of the bag defined by the edges 43 and 44 is folded up to overlie the closed end portion as indicated by the arcuate arrow in FIG. 8, and the pull tab 30 is applied to one side of the open end, by an adhesive, heat seal or the like at 48. Then the bag is folded upon itself as shown in FIG. 9, bringing it to the position shown in FIG. 1.

Finally, the retainer wings 29 are folded over and interlocked, by means of the slotted tabs 34. The cartridge 23 then is ready for insertion in the tool 10 for use. Of course, a plurality of cartridges can be packaged for sale as a supply to last for a long period of time.

The clip 21 on the carrier 22 is formed in the rear portion of the carrier by a V-shaped notch 50 in the rear edges 51 and 52 of the top and bottom walls, leading to an enlarged opening 53 in each wall beyond restricted throat 54 at the inner open end of the notch 50. This is used to close the bag 12, as will be described.

Shown in FIG. 10 is a first modified embodiment of the carrier of the present invention, providing the same capabilities as the folded cardboard carrier 22 in a flat, general rectangular box-like configuration that is composed of stiff plastic sheet material formed into substantially the same shape. This plastic carrier also is shown in FIGS. 2-5 and has a flat bottom well 57, upstanding sidewalls 58 supporting retainers 0.59 which project inwardly over the bottom wall 57 from the top edges of the sidewalls 58 and preferably are formed with transverse braces 60 and a pattern of bumps 61 for holding a bag releasably in place in the cartridge. Detents 62 are offset from the bottom wall 57 for positioning engagement with the tool 10, and a ridge 62a, a tab 62b and ribs 62c may be provided on the bottom wall for the same purpose.

A V-shaped notch 63 is formed in the rear edge 64 of the bottom wall 57 and opens into a central opening 65, through a restricted throat 67, all preferably stiffened by a rib 68 in the bottom wall. This forms a clip 69 in the rear portion of the carrier 55, so the carrier is functionally and structurally quite similar to the carrier 22 of the first embodiment, except for the material and manner of manufacture.

The second modified embodiment of the carrier is shown in FIG. 11 as a one-piece molding 70 of rigid transparent plastic having a flat bottom wall 71, upstanding sidewalls 72, and a top wall which is simply an integral strap 73 spanning the sidewalls at the front end of the carrier, and two overhanging top flanges 73a at the rear of the cavity for holding a folded bag (not shown). The clip 74 in this case is formed by a V-shaped notch 75 in the rear edge of the carrier 70, defined by molded continuations of the sidewalls 72 that extend entirely around the rear of the carrier, into the notch 74 and on both sides of a restricted throat 77 and into a central opening 78, defined on its rear sides by the ends 79 of the upright walls. Ribs 80 and posts 81 in the clip-end portion of the molded carrier 70 provide locating end surface in the sunken areas on opposite sides of the notch, for positioning the carrier in a tool.

With this carrier 70, a folded bag (not shown) can be fitted under the top wall formed by the strap 73 and the overhanging flanges 73a at the rear of the bag cavity, and suitably secured to the bottom wall 71, preferably by heat sealing or by an adhesive. As with the other two embodiments, the bag may be pulled out of the carrier for use.

Each of these embodiments can be mass-produced at relatively low cost and sold in bulk packaging for use with a tool of the general type shown in the above-identified patent application. A cartridge containing a folded bag 12 is inserted into the tool and received in a seat therein, preferably with a “snap” fit and with a pull tab 30 projecting forward for easy access. When the tool 10 is to be used to pick up a piece of refuse, such as the piece 11 in FIGS. 4 and 5, the bag 12 is grasped and extended as shown in FIGS. 2 and 3, and then opened and folded over the tool as shown in FIG. 4, the closed end of the bag remaining attached to the carrier, which remains seated in the tool.

When the piece 11 has been gripped between the closed jaws 19 and 20, and between the walls of the bag 12 lining the tool, the carrier is pulled beneath the handle 14 and rearwardly away from the jaws 18 and 19, drawing the bag 12 and the piece of enclosed refuse 11 out of the tool, as shown in FIG. 5. Before the open end of the bag clears the head, however, the carrier is folded over the adjacent portion of the bag and the V-shaped notch is pressed over the bag to force it through the throat and into the enlarged opening in the bottom wall. This effectively closes the bag around the refuse 11 for disposal. The bottom wall 24 of the tool is formed with a rearwardly opening notch 26 shown in FIG. 5 to restrain the front end portion of the bag as it is pulled through the tool. This tool releasably holds the open end portion of the bag as the clip is being applied.

From the foregoing, it will be seen that the present invention provides a simple and effective cartridge for holding a folded bag 12 ready for access and use and for drawing the bag out of a tool 10 while closing and sealing the bag for disposal, all without need for any unpleasant contact with the refuse. It also will be evident that, while three embodiments have been illustrated and described, other modifications and changes may be made without departing from the invention.

1. A disposable refuse bag cartridge for use in a tool having a gripper head with a manually operable opening and an open rear side, said cartridge comprising:
a flat box-like carrier for a refuse bag having a flat bottom wall, upright side edges on the bottom wall, and retainers extending inwardly from the side edges over the bottom wall to define a bag-holding cavity over the bottom wall and an open front side for said cavity,
said carrier having a rear portion beyond the cavity forming a clip for closing the bag after use, said rear portion having a rearwardly opening V-shaped notch in one edge, a restricted throat at the inner end of the notch, and an enlarged opening beyond the throat for receiving a bag through the throat and holding the bag closed;
and a folded refuse bag disposed on said carrier and comprising opposed elongated sheets of thin plastic film joined together to form the bag with a closed end and an open end, said bag being folded along longitudinal fold lines into an elongated narrow strip, and then folded along a transverse fold line to bring the open end over the closed end, and then folded upon itself into flat, generally rectangular condition;
said bag being disposed in said bag-holding cavity over said bottom wall and beneath said retainers with said open end of the bag at said front side of said carrier and said closed end of the bag being secured to said carrier;
said bag being extendable from said carrier through said opposite side of said cavity for use in picking up refuse, and said carrier clip being engageable with the bag after use to close the bag around the refuse for disposal.

2. A bag cartridge as defined in claim 1 further including a tab secured to the open end of said bag at said open side and projecting out of the carrier to be gripped to pull the bag from the carrier.

3. A bag cartridge as defined in claim 2, wherein the bag has a beveled open end forming central end edges on a central portion of said bag that are approximately the same width as said cavity, the bag being folded longitudinally from both sides over the central position.

4. A bag cartridge as defined in claim 3, wherein the sheets of plastic film are offset at said end edges, to expose one of the sheets, and said tab is attached to the exposed sheet.

5. A bag cartridge as defined in claim 1, wherein said carrier is a sheet of cardboard having a flat central portion forming said bottom wall, weakened lines forming fold lines between the sides of said bottom wall and said side edges, and additional weakened lines forming fold lines between either side edges and said retainers, said retainers being wing-like portions of said cardboard sheet.

6. A bag cartridge as defined in claim 5, wherein said cardboard sheet also includes tabs on said retainers interlocked over the cavity to hold said retainers in place over the folded bag.

7. A bag cartridge as defined in claim 6, wherein said clip is formed by V-shaped notches in said cardboard sheet extending into said bottom wall and said retainers, and said opening is formed by aligned openings in said bottom wall and said retainers.

8. A bag cartridge as defined in claim 1, wherein said carrier comprises rigid plastic sheet material forming said bottom wall, integral side edges on side bottom wall, and retainers extending inwardly over the bottom wall to define the cavity, said clip being formed by a notch in the rear side of the bottom wall and a restricted throat and enlarged central opening, also formed in said bottom wall.

9. A bag cartridge as defined in claim 1, wherein said carrier comprises a one-piece rigid plastic molding having a flat bottom wall, integrally molded sidewalls extending along the side edges of the bottom wall, an integral plastic strap spanning the sidewalls at the front end of the carrier, two overhanging flanges defining the rear end of the cavity, and an integrally molded clip.

10. A bag cartridge as defined in claim 9, wherein said clip is defined by continuations of said sidewalls forming a V-shaped notch in the rear side of the carrier, said sidewalls defining a restricted throat at the inner end of the notch and a portion of a central opening in the carrier beyond the throat.

11. A bag cartridge as defined in claim 10, wherein said plastic is transparent and said sidewalls define sunken areas on opposite sides of said notch, and further including upstanding positioning elements on said bottom wall in said sunken areas with ends providing positioning surfaces for said cartridge.

12. A refuse bag cartridge, comprising:
a carrier for a folded refuse bag having a bottom wall, retainers overlying the bottom wall to hold down a folded bag and an open front side for withdrawal of a bag from the carrier;
and a folded refuse bag releasably held on said carrier and having an open end disposed at said open side of the carrier, the refuse bag being extendable from the carrier through said open side and openable from the folded condition to be placed over refuse to be picked up.

13. A refuse bag cartridge as defined in claim 12, wherein said carrier has a closure clip on a side thereof remote from said front side, said closure clip including an opening shaped to be fitted around the bag in the extended condition to close and seal the bag around the refuse.

14. A refuse bag cartridge as defined in claim 13, wherein said closure clip is formed by a notch in the side of the carrier opposite said open front side, a restricted throat at the inner end of the notch, and an enlarged opening for receiving and holding the bag.

15. A refuse bag cartridge as defined in claim 12, wherein said bag has a closed end attached to said carrier.

16. A refuse bag cartridge as defined in claim 12, wherein said carrier is a sheet of cardboard having a flat portion forming said bottom wall side edges formed to said bottom wall by folds in the cardboard, and retainers in the form of wings overlying the bottom wall and joined to the sidewalls by additional folds.

17. A refuse bag cartridge as defined in claim 16, wherein said retainer wings are joined together by interlocking tabs overlying said folded bag.

18. A refuse bag cartridge as defined in claim 16, wherein said cardboard sheet has a notch in rear side thereof, opposite said front side, and a restricted opening at the inner end of the notch for receiving and holding the extended bag.

19. A refuse bag cartridge as defined in claim 12, wherein the carrier is composed of stiff plastic sheet material and said bottom wall, side edges and retainers are integrally joined together.

20. A refuse bag cartridge as defined in claim 12, wherein the carrier is composed of rigid molded plastic.
